(19) United States
(12) Patent Application Publication
(10) Pub. No.: US 2005/0279869 A1
(43) Pub. Date: Dec. 22, 2005

(54) Portable shredder

(76) Inventor: Kevin Barklage, Virginia Beach, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 11/150,387

(22) Filed: Jun. 11, 2005

Related U.S. Application Data
(60) Provisional application No. 60/579,759, filed on Jun. 16, 2004.

(51) Int. Cl. B02C 18/16

(52) U.S. Cl. 241/100; 241/236

(57) ABSTRACT

The invention includes a plurality of parts or elements including at least a cap removably coupled with a container formed in the shape of a cup to provide a portable shredder that may be employed mounted in an automobile for destroying receipts and the like to prevent identity theft. The portable shredder comprises at least one rotating shaft having a first plurality of circular blades that engage a second set of blades to shred a receipt as it passes between the first and second sets of blades. The exterior shredder may be formed in the shape of a cup to be easily accommodated by a cup holder in an automobile. Otherwise, the shredder may be incorporated into an automobile part such as a door, console, dash or the like and installed during manufacture of the automobile.

This application claims priority from U.S. Provisional Patent Application Ser. No. 60/579,759 filed on Jun. 16, 2004.

The patent application did not receive federal research and development funding.

### BACKGROUND OF THE INVENTION

The invention is generally directed to a portable shredder specifically adapted for shredding receipts and the like. More specifically, the invention is directed towards a portable shredder for use in an automobile.

Identity theft is an increasing problem in modern society. Careless discarding of financial and personal information contributes to identity theft. One means of combating this problem is by shredding credit card receipts and the like.

U.S. Pat. No. 5,054,695 teaches a hand-held shredder for sheets of paper. U.S. Pat. No. 4,869,435 teaches a pocket paper shredder. U.S. Pat. No. 4,798,116 discloses a document shredding machine. U.S. Pat. No. 5,853,131 discloses a desktop paper shredder. Each of these patents appear to teach cutting mechanisms that shred paper and the like.

The aforementioned U.S. Patents are illustrative of prior art shredding devices. However, none of these patents disclose a shredder that may be mounted or fitted into an automobile cup holder nor do they disclose or suggest a shredder having an exterior appearance of a cup.

### BRIEF SUMMARY OF THE INVENTION

In a first embodiment, the present invention is a portable shredder having an exterior housing formed generally in the shape of a cup such that the shredder may be easily mounted in an automobile cup holder. The shredder includes a power cable having a connector that provides power from a direct current automobile power source. The portable shredder may include a battery compartment and a one or more batteries for use when the power cable is disconnected. The power source may include a charging circuit and a pair of rechargeable batteries. In the first embodiment, a motor and a shredder assembly are mounted in a top cap that is coupled to a cup-shaped container for receiving shredded paper. The top cap is formed in a dome shape that includes an opening through a receipt or other small strip of paper is passed for shredding purposes. The shredder assembly comprises a pair of blades that intertwine to shred a paper receipt into multiple pieces. An additional pair of blades arranged between the first pair of blades and the container for cross-shredding the paper after it passes through the first pair of blades.

In a second embodiment, the shredder is constructed of a three-piece assembly comprising a cap which may include a first pair of shredder blades, a mid-mount that includes a shredder assembly and a second pair of shredder blades. A motor or a pair of motors drives the shedder blades. A bottom cup-shaped container receives the shredded paper. In a third embodiment, the motor is mounted in a bottom of the shredder and a transmission shaft extends from the bottom to mid-mount to rotate at least one shaft to cause the blades mounted thereon to cut a paper receipt into multiple pieces.

In a further embodiment, the shredder is built into a dash, console or other interior part of an automobile during the manufacturing process of the automobile. In this embodiment, the shredder includes a cover plate through which the receipt or other piece of small paper having personal identifier information is shredded.

It is an object of the present invention to provide a portable shredder having a unique shape for mounting and using it in a cup holder of an automobile. In a further embodiment, the shredder is permanently mounted in dash or console of an automobile.

It is an object of the invention to provide a shredder having a base with a radius that is small enough to be accommodated by an automobile cup holder for use in destroying or shredding credit card receipts and the like to prevent identity theft. Typically, the radius of the base of the shredder is smaller than or equal to approximately 2.5 to 3 inches. However, it can be recognized that other shredders having larger or smaller radiuses may utilized.

It is a further object of the invention to provide a shredder having a plurality of elements that snap-fit together to create a cup-shaped shredder. An edge of one element that is in contact with another element is slightly larger, typically the thickness of the outer wall of the element onto which it fits. For example, the lower edge of the top may have a radius that is 0.125 inches larger than the radius of the upper edge of the mid-mount, if the thickness of the wall of each is 0.125 inches thick. Likewise, the lower edge of the mid-mount may be 0.125 inches larger in radius than the radius of the upper edge of the base. In this manner, the shredder may be easily disassembled for removing shredded paper from a storage area and/or cleaning the shredder assembly comprising at least one shaft having a plurality of rotating blades.

It is further an object of the invention to provide a shredder permanently mounted in the dash, door or console of an automobile and having an accessible storage area for temporarily storing shredded paper therein.

The above and further objects, details and advantages of the invention will become apparent from the following detailed description, when read in conjunction with the accompanying drawings.

### BRIEF DESCRIPTION OF THE DRAWINGS

FIG. 1A is a perspective view of a first embodiment of the invention. FIG. 1B depicts the first embodiment of the invention with a protective cap removed to allow access to a drive motor coupled to at least one blade shaft. FIG. 1C shows the drive motor coupled to both blade shafts via gears. FIG. 1D is a cross section view of FIG. 1A taken from line D-D.

FIG. 2A is a perspective view of a second embodiment of the invention. FIG. 2B shows the protective cap removed from the shredder. In this embodiment, the motor is located remote from the blades. FIG. 2C is an exploded view of the second embodiment of the invention.

FIG. 3 is a perspective view of the invention showing the shredder mounted in a drink holder of an automobile.

### DETAILED DESCRIPTION OF THE INVENTION

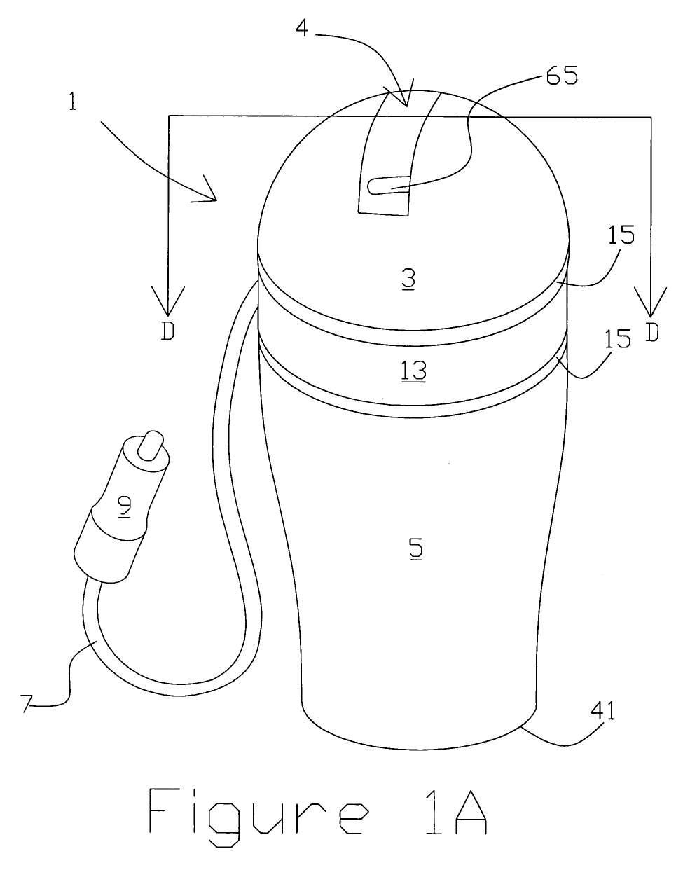

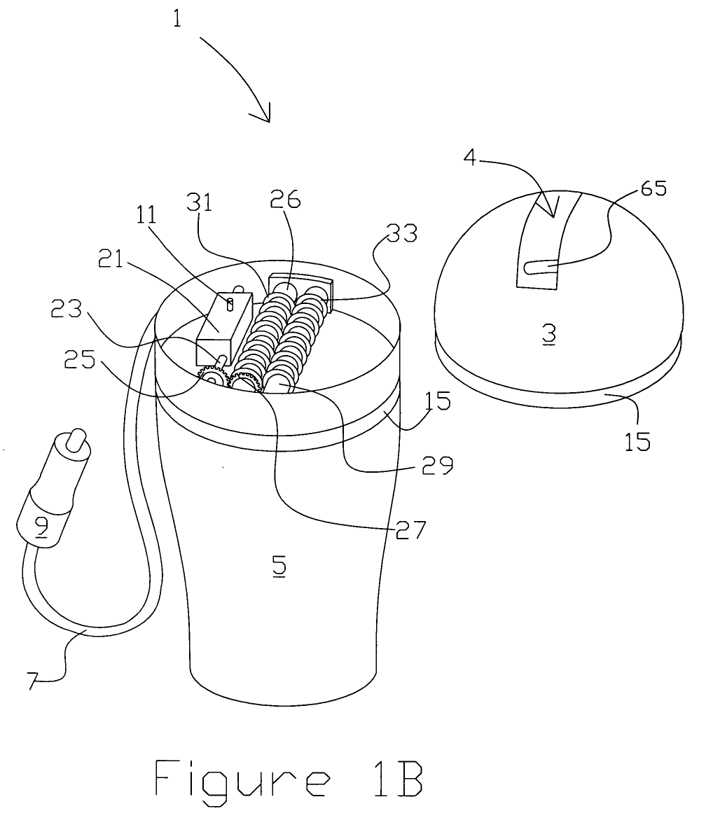

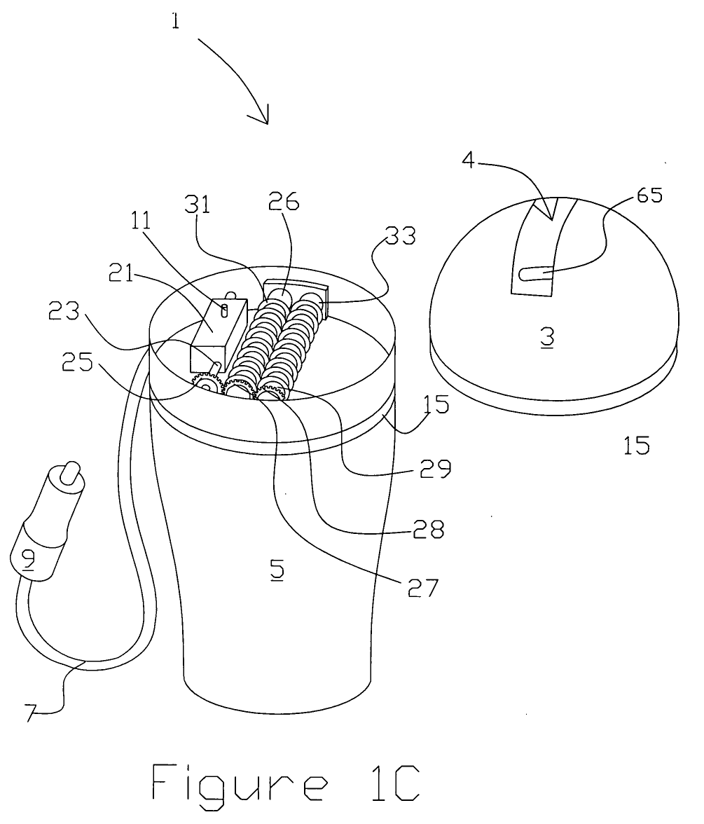

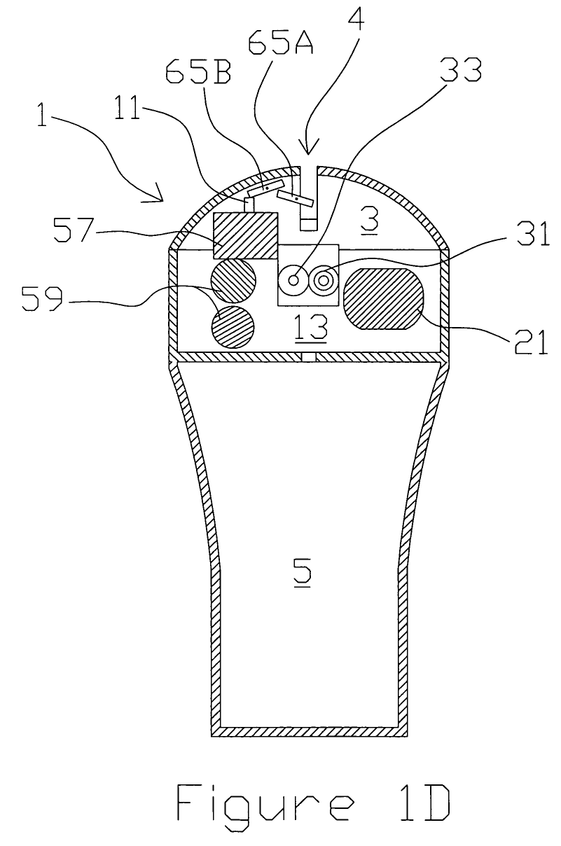

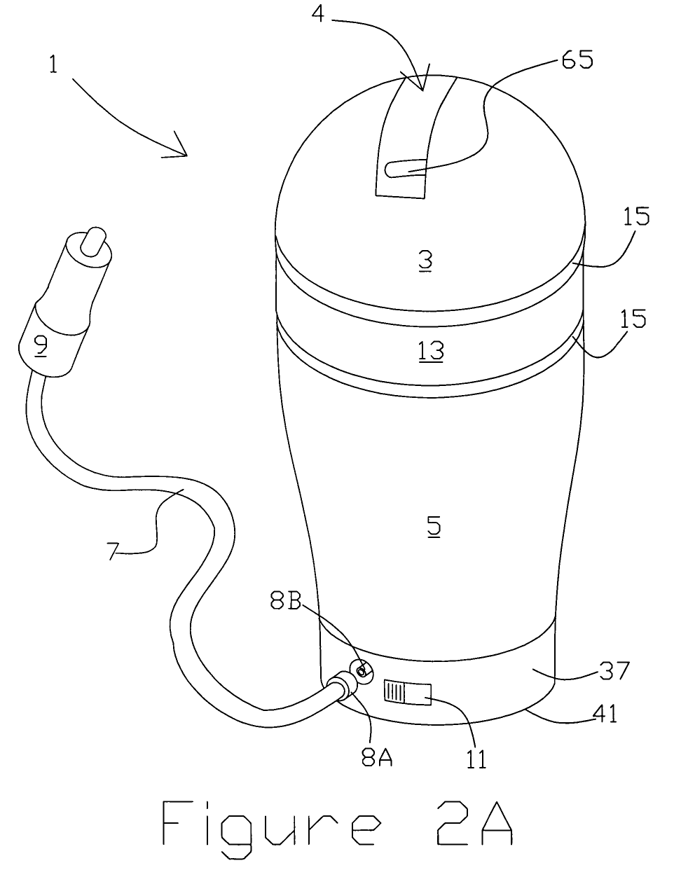

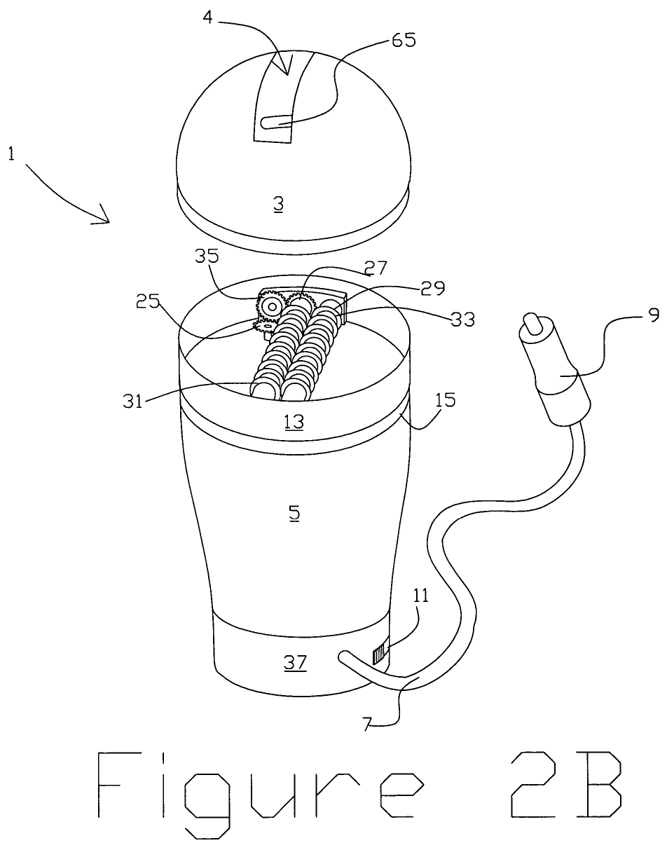

FIGS. 1A through 1C show a first embodiment of the portable shredder for use in an automobile. The shredder 1 includes a protective cap 3, a shredder mount 13 and a storage container 5. The protective cap 3 is generally formed in the shape of a dome and includes an opening 4, as shown. This unique shape allows the inner workings of the shredder including the blades to be arranged below the opening 4. When assembled, the storage container 5 generally has a shape corresponding to that of a drinking cup and includes a circular base 41. The circular base 41 comprises a radius of a size that fits into an automobile cup holder. Typically, the radius is approximately 2.5-3.0 inches. A power cord 7 includes a plug 9 that mates with a D.C. power supply receptacle, such as a cigarette lighter receptacle, of an automobile. The power cord 7 may include a second plug 8A, as shown in FIG. 2A. If so, then a complementary connector 8B is provided in base 41 for coupling the power cord to the motor or rechargeable power supply. Alternatively, the power cord 8 may be hard wired into the shredder as shown in other figures. The protective cap 5 includes an opening 4 for feeding receipts and other small papers having identifying information there through. Typically, cap 5, shredder mount 13 and storage container 5 are formed from plastic and snap-fit together. Lips 15 may be provided on the cap 5 and shredder mount 13 for sliding over an upper edge of the shredder mount 13 and container 5, respectively. Otherwise, the cap 5, mount 13 or container 5 may be formed with internal and external threads and screwed together. A switch activating mechanism 65, more clearly shown in FIG. 1D, activates the shredder 1 as paper is fed into the opening 4.

In FIG. 1B, the cap 3 is shown removed. Access to the interior of the shredder 1 is provided by removing the cap 3. This allows a user to perform cleaning and maintenance of the blades 31, blade shafts 27 and the gears 25, 27. In this first embodiment, the motor 21 couples to movable-blade-shaft 26 via motor shaft 23, motor gear 25 and blade shaft gear 27. Motor 21 drives motor shaft 23, which in turn, drives motor gear 25. Motor gear 25 is coupled to blade shaft gear 27 and drives it to cause shaft 26 to rotate. Rotating blades 31 are fixed to shaft 26 and rotate accordingly. As shown, rotating blades 31 are intertwined with fixed blades 33 which are mounted on fixed shaft 29. A pair of switch activators 65A, 65B is mounted in the cap 3. Opening 4 aligns with the intersection between the rotating and fixed blades 29, 31, such that when a receipt or other form of paper is fed into the shredder 1, it pushes a first end of switch activator 65A downward which in turn forces a second end of switch activator 65A upward. The second end of activator 65A forces a first end of activator 65B upward causing the second end of the activator 65B to depress switch 11, thereby energizing motor 21. The strip of paper passes between the blades to be effectively cut into small strips and deposited into the storage container 5.

In FIG. 1C, a second gear 28 is coupled to blade shaft 27 causing it to rotate in an opposite direction to blade shaft 26. This advantageously pulls paper into the blades when the shredder is in operation, while helping to expel the paper from the shredder when direction of rotation of the blades is reversed by reversible switch 11, shown in FIG. 2A-2C. FIG. 1D is a cross sectional view of the first embodiment of the invention. Switch activators 65 are more clearly shown. It can be easily recognized that the activators each comprise an axis about which they rotate. The axis may be a pin upon which each is mounted. A printed circuit board 57 comprises a charging circuit for charging rechargeable batters 59 which in turn supply power to motor 21.

FIGS. 2A through 2C show an additional embodiment of the invention wherein the motor is remotely located from the shredder mount. An additional motor module 37 is provided below the container 5. Power switch 11 is provided for energizing the motor 5 to rotate the blades 32 and is a reversible switch that reverses the direction of rotation of motor 5. FIG. 2B depicts the shredder having protective cap 3 removed to show the shredder mount 13. An additional drive gear 35 is arranged to transmit rotational energy from the motor 21 blade shaft 26. A transmission shaft 41 extends from motor module 37 upwards through container 5 and is coupled to motor gear 25. A transmission shaft support 43 is provided against a sidewall of container 5 for supporting the transmission shaft 41 and preventing shredded material from contacting and damaging the shaft 41. The transmission shaft support 43 is generally formed from the same material as the container 5.

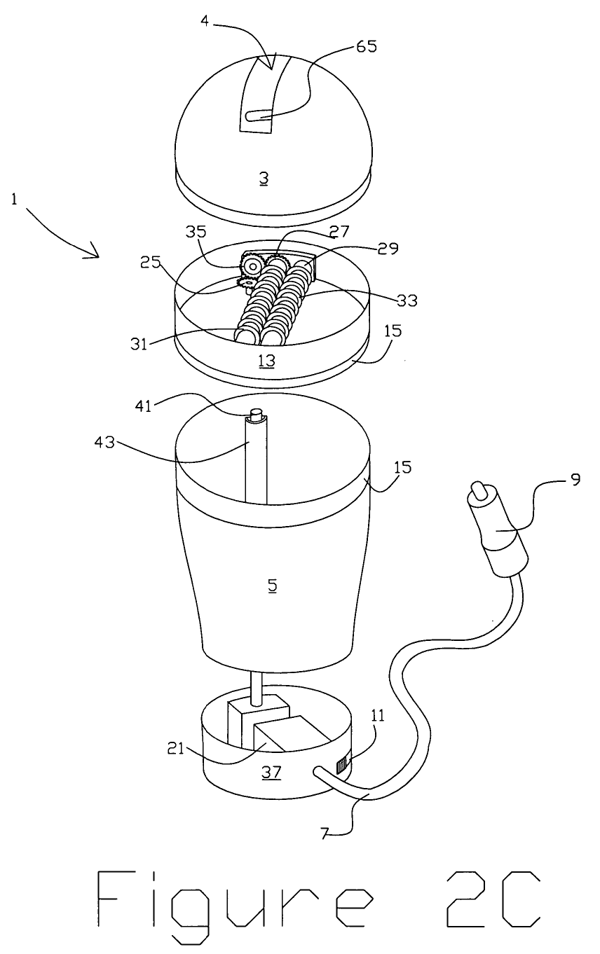

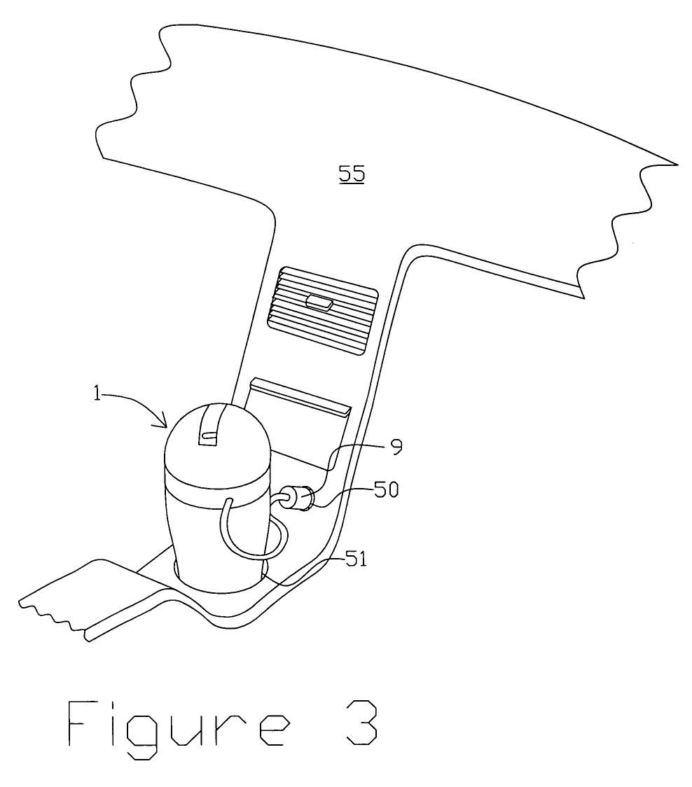

FIG. 3 is a perspective view showing the shredder 1 mounted in a cup holder 51 of an automobile console 55. Power connector 9 is inserted into a cigarette lighter receptacle 50 or other automobile power source connector. It should be noted that the shredder may constructed during the manufacturing process of the automobile as previously mentioned.

It is to be understood that the invention is not limited to the exact construction illustrated and described above, but that various changes and modifications may be made without departing from the spirit and the scope of the invention as defined in the following claims.

1. A portable shredder for destroying paper copies having personal identifier information, said portable shredder comprising:
a protective cap having an opening through which paper is to be shredded is passed, said protective cap including a lip;
a pair of blade shafts arranged below said protective cap, each blade shaft having a plurality of blades arranged thereon for shredding paper that passes through said opening;
a motor coupled to at least one of said blade shafts to cause the blade shaft to rotate when the motor is energized;
a power source coupled to said motor for providing electrical energy thereto;
a switch connected to and arranged between said motor and said power source for energizing said motor; and,
a shredded paper storage area formed in the shape of a cup and having an upper edge, such that said shredder may be mounted in a cup holder of an automobile;
wherein said lip of the protective cap overlaps the upper edge of the shredded paper storage area.

2. The portable shredder of claim 1 further comprising a shredder mount arranged between said protective cap and said shredded paper storage area.

3. The portable shredder of claim 1 further comprising a power cord for supplying power from an external power source.

4. The portable shredder of claim 3 wherein said power cord comprises a direct current connector for providing electrical energy to the shredder from an automobile electrical source.

5. The portable shredder of claim 4 further comprising a second direct current connect for detaching and attaching the power cord to the portable shredder.

6. The portable shredder of claim 1 further comprising a switch activator assembly that comprise a first and a second switch activator, both said first activator and said second activator having a first end and a second end and arranged such that when a strip of paper is fed into the opening of the cap the first end of the first activator is forced downward causing the second end of the first activator to be forced upward, said second end of the first activator being in contact with the first end of the second activator such that said second end of the first activator forces the second activator upward to cause the second end of the second activator to be forced downward to cause the switch to be closed such that the motor is energized.

7. The shredder of claim 1 wherein said motor is arranged at a base of the shredded paper storage area further comprising a transmission shaft coupled to the motor and having a gear arranged at an opposite end for driving at least one of the blade shafts.

8. The shredder of claim 1 further comprising a printed circuit board that includes a charger circuit for charging at least one rechargeable battery.

9. The shredder of claim 1 wherein said switch is reversible.

10. A portable shredder for destroying paper copies having personal identifier information, said portable shredder comprising:
a protective cap having an opening through which paper is to be shredded is passed, said protective cap including a lip;
a pair of blade shafts arranged below said protective cap, each blade shaft having a plurality of blades arranged thereon for shredding paper that passes through said opening;
a motor coupled to at least one of said blade shafts to cause the blade shaft to rotate when the motor is energized;
a power source coupled to said motor for providing electrical energy thereto;
a switch connected to and arranged between said motor and said power source for energizing said motor;
a switch activator assembly that comprise a first and a second switch activator, both said first activator and said second activator having a first end and a second end and arranged such that when a strip of paper is fed into the opening of the cap the first end of the first activator is forced downward causing the second end of the first activator to be forced upward, said second end of the first activator being in contact with the first end of the second activator such that said second end of the first activator forces the second activator upward to cause the second end of the second activator to be forced downward to cause the switch to be closed such that the motor is energized; and,
a shredded paper storage area formed in the shape of a cup and having an upper edge, such that said shredder may be mounted in a cup holder of an automobile;
wherein said lip of the protective cap overlaps the upper edge of the shredded paper storage area.

11. The portable shredder of claim 10 further comprising a shredder mount arranged between said protective cap and said shredded paper storage area.

12. The portable shredder of claim 10 further comprising a power cord for supplying power from an external power source.

13. The portable shredder of claim 12 wherein said power cord comprises a direct current connector for providing electrical energy to the shredder from an automobile electrical source.

14. The portable shredder of claim 13 further comprising a second direct current connect for detaching and attaching the power cord to the portable shredder.

15. The shredder of claim 10 wherein said motor is arranged at a base-of the shredded paper storage area further comprising a transmission shaft coupled to the motor and having a gear arranged at an opposite end for driving at least one of the blade shafts.

16. The shredder of claim 10 further comprising a printed circuit board that includes a charger circuit for charging at least one rechargeable battery.

17. The shredder of claim 10 wherein said switch is reversible.
